(19) United States
(12) Patent Application Publication
(10) Pub. No.: US 2025/0218630 A1
(43) Pub. Date: Jul. 3, 2025

(54) High-performance and high-thermal-stability sintered NdFeB magnet and preparation method thereof

(71) Applicant: Yantai Dongxing Magnetic Materials Inc., Yantai (CN)

(72) Inventors: Chunjie XIANG, Yantai (CN); Zhongjie PENG, Yantai (CN); Xiaonan ZHU, Yantai (CN); Jijun DU, Yantai (CN); Kaihong DING, Yantai (CN)

(73) Assignee: Yantai Dongxing Magnetic Materials Inc., Yantai (CN)

(21) Appl. No.: 18/990,210

(22) Filed: Dec. 20, 2024

(30) Foreign Application Priority Data
Dec. 29, 2023 (CN) 202311846265.9

(51) Int. Cl. H01F 1/057; C22C 38/00; C22C 38/06; C22C 38/10; C22C 38/14; C22C 38/16; H01F 41/02

(52) U.S. Cl. CPC H01F 1/0577; C22C 38/002; C22C 38/005; C22C 38/06; C22C 38/10; C22C 38/14; C22C 38/16; H01F 41/0253; C22C 2202/02

(57) ABSTRACT

Provided are a NdFeB magnet with high-performance and high-thermal-stability and a preparation method thereof, and relates to the technical field of a NdFEB magnet. The NdFEB magnet of the present application includes a main phase Re₂Fe₁₄B, a grain boundary phase containing Re and a rare earth-rich phase, where the grain boundary phase includes a first grain boundary phase and a second grain boundary phase, the first grain boundary phase is a Ga+Cu-rich amorphous phase at a grain boundary triangle region, and the second grain boundary phase is a Ga+Cu-rich amorphous grain boundary phase formed among adjacent main phase grains, and a mass content ratio of Cu to Ga in the magnet is 1.8 to 10. The present application improves the thermal stability of the magnet by transforming the Re-rich grain boundary phase into an amorphous phase.

### CROSS-REFERENCE TO RELATED APPLICATION(S)

This application is based on Chinese Patent Application No. 202311846265.9, filed Apr. 26, 2024, which claims the benefit of priority to the Chinese Patent Application, which is incorporated by reference in its entirety herein. No new matter has been introduced.

### FIELD

The present disclosure relates to the technical field of NdFeB magnet preparation, and more particularly to a high-performance and high-thermal-stability sintered NdFeB magnet and a preparation method thereof.

### BACKGROUND

Sintered NdFeB material, as an important functional material, is widely used in new energy vehicles, information technology, medical equipment and other fields. With the development of technology, the requirements for the comprehensive magnetic properties of NdFEB magnets are becoming increasingly stringent, especially in terms of temperature stability.

In the prior art, in order to meet the high temperature performance requirements, coercivity is generally increased by adding heavy rare earth elements or by diffusion.

As described in research article “The Effect of Adding Dy on Thermal Stability and Magnetic Domains of NdFeB Magnets”, temperature stability of a magnet is improved by adding the element Dy. Dy mainly enters a main phase and forms Dy₂Fe₁₄B inside a grain, which significantly increases the anisotropy field of the magnet and further increases the coercive force of the magnet. Meanwhile, since Dy replaces Nd atoms, Nd atoms diffuse into the grain boundaries, improving microstructure, enhancing magnetic properties, and further improving thermal stability of the magnet. For another example, in the research article “Effect of Grain Boundary Addition of Dy₈₀Fe₁₃Ga₇ on Thermal Stability and Corrosion Resistance of Sintered NdFeB”, the coercive force of a magnet is improved by adding Dy₈₀Fe₁₃Ga₇ alloy to grain boundaries, in which with the increase in the number of rare earth-rich grain boundary phases, the demagnetizing exchange coupling between the main phase grains is enhanced, significantly improving the coercive force and thus improving the temperature coefficient of the magnet. The above methods add heavy rare earth elements or heavy rare earth compounds, which essentially improve the high temperature performance of the magnet by increasing the coercive force of a magnet and improving the temperature stability of a magnet, and the cost is relatively high.

The Chinese patent with publication number CN106158203B disclosed a preparation technology for improving the thermal stability of NdFeB magnets, wherein NdFEB and SmFeN magnetic powders were subjected to high-energy ball milling, powder mixing, magnetic field orientation pre-pressing and spark plasma sintering to prepare magnets. The thermal stability of NdFeB was improved by taking advantage of the high intrinsic properties of SmFeN (Curie temperature 470° C.). However, this process produces nanocrystalline powder, which was different from the conventional NdFeB production process, and the magnetic properties of the magnet were lower.

Based on these, the present disclosure provides a NdFeB magnet and a preparation method thereof, which can improve the temperature stability of the magnet to meet the current demand for high temperature performance.

### SUMMARY

Purpose of the disclosure: in order to overcome the deficiencies in the prior art, the present disclosure provides a NdFeB magnet and a method for preparing the same, and improves the temperature stability of the NdFeB magnet.

Technical solution: to achieve the above-mentioned purpose, a high-performance and high-thermal-stability sintered NdFeB magnet is provided, and the NdFeB magnet includes a Re₂Fe₁₄B main phase, a grain boundary phase containing Re and a rare earth-rich phase, the grain boundary phase including a first grain boundary phase and a second grain boundary phase; the Re is one or more of rare earth elements and contains at least one of Pr and Nd, the first grain boundary phase is a Ga+Cu-rich amorphous phase in the grain boundary triangle region, the second grain boundary phase is a Ga+Cu-rich amorphous grain boundary phase formed among adjacent main phase grains, and the rare earth-rich phase is Re—O and Re—N; a mass percentage of the Re₂Fe₁₄B main phase, the first grain boundary phase and the second grain boundary phase in the NdFEB magnet is defined as X, 97%≤X<100%.

Further, on any cross-section of the NdFeB magnet, an area percentage of the first grain boundary phase is 6% to 15%, and a width of the second grain boundary phase is 2 nm to 20 nm; a total mass of Ga and Cu in the first grain boundary phase accounts for 20% to 40% of a total mass of the first grain boundary phase, and a mass content of Fe in the first grain boundary phase is 0% to 10%; a total mass content of Ga and Cu in the second grain boundary phase accounts for 40% to 70% of a total mass of the second grain boundary phase, and a mass content of Fe in the second grain boundary phase is 0% and 10%.

Further, elements and their contents in the NdFEB magnet are: Re: 29.5 wt % to 33 wt %, B: 0.85 wt % to 0.98 wt %, M: 0.5 wt % to 5 wt %, Fe: 61 wt % to 69 wt %; M containing at least two elements, Cu and Ga, and at least one of Co, Ti, Zr, V, Mo, and Nb, and a mass content of Cu is greater than 0.45%, and a mass content of Ga is less than 0.25%, where a mass content ratio of Cu to Ga is defined as Y, 1.8<Y≤10.

A method for preparing a high-performance and high-thermal-stability sintered NdFeB magnet including the following steps:
(S1) mixing materials and preparing an alloy flake by using a strip casting process, where a smelting process in the strip casting process is performed under argon protection;
(S2) treating the alloy flake with hydrogen and pulverizing by air-jet milling;
(S3) magnetic-forming the alloy powder in a uniform magnetic field, and preparing a green body by cold isostatic pressing;
(S4) sintering the green body in a vacuum sintering furnace, and then performing an aging treatment, where the aging treatment is a two-stage tempering heat treatment, and a thermal-insulation stage and a cooling structure in the two-stage tempering heat treatment are both performed under an inert atmosphere.

Further, a temperature of the smelting process in (S1) is 1400° C. to 1500° C.

Further, a particle size of the alloy powder prepared by air-jet milling in (S2) is 2.5 μm to 5 μm.

Further, a magnetic field intensity for magnetic-forming in (S3) is 1.5T to 2T.

Further, a sintering temperature of the sintering process is 1030° C. to 1080° C. and the sintering time is 6 h to 10 h in (S4).

Further, a temperature of the primary tempering heat treatment is 800° C. to 900° C., and a time of the thermal-insulation is 3 h to 5 h; a temperature of the secondary tempering heat treatment is 460° C. to 520° C., and a time of the thermal-insulation is 1 h to 6 h in (S4).

Further, the inert atmosphere in (S4) is argon, where a pressure of the inert atmosphere in the thermal-insulation stage is 0.02 MPa to 0.05 MPa, and a pressure of the inert atmosphere in the cooling stage is 0.06 MPa to 0.08 MPa.

The present disclosure has the following technical effects:

The magnet structure has an important influence on the magnet performance, and existing studies have shown that both high Ga and high Cu magnets can form Nd—Fe-M series compounds, but since that Nd—Fe—Ga (−0.046 eV/atom) has a lower formation energy than Nd—Fe—Cu (0.005 eV/atom), thereby Nd—Fe—Ga is preferentially generated and the formation of Nd—Fe—Cu is suppressed, which leads to the separation of grain boundary phases in the magnet, that is, a part has a Ga-rich region with Nd—Fe—Ga structure, and the other part contains Cu-rich region, where the uneven structure of the grain boundary triangle region further leads to uneven grain boundary phases between the two particles, and some have better grain boundary phases between the two particles, while others have no grain boundary phases, whereas the unevenness of this structure leads to reduced magnet performance and poor stability.

In the present disclosure, the composition of the alloy is reasonably regulated to reduce the formation of Nd—Fe—Ga, the low melting point characteristic of Nd—Cu is utilized to improve the liquid phase fluidity of the grain boundary phase, thereby improving the wettability of the main phase and the rare earth-rich phase. In combination with the rapid cooling process, the enrichment of Cu is suppressed, and the simultaneous enrichment of Ga and Cu is achieved, so that the element distribution is more uniform, improving the uniformity of the magnet organization, and forming a magnet with a good continuous grain boundary phase, which is conducive to improving the magnet performance.

In addition, by introducing an inert gas to a certain pressure during the two-stage aging and cooling stages, the flow of the grain boundary phase during the aging and thermal-insulation process is promoted, thereby forming an excellent grain boundary phase, improving the cooling rate in the cooling stage. Utilizing the characteristic that the Cu-rich compound is easy to form an amorphous structure, the grain boundary phase is transformed from a crystalline structure to an amorphous structure, thereby improving the temperature stability of the magnet.

### BRIEF DESCRIPTION OF THE DRAWINGS

FIG. 1 is a magnet microstructure diagram in Example 1;

FIG. 2 is the amorphous diffraction pattern at the triangle region of the magnet grain boundary in Example 1;

FIG. 3 is an energy spectrum analysis diagram of a magnet grain boundary triangle region in Example 1;

FIG. 4 is an energy spectrum analysis diagram of two crystal grains of the magnet in Example 1;

FIG. 5 is a crystal diffraction pattern at the triangle region of the magnet grain boundary in Comparative Example 1.

### DETAILED DESCRIPTION OF THE EMBODIMENTS

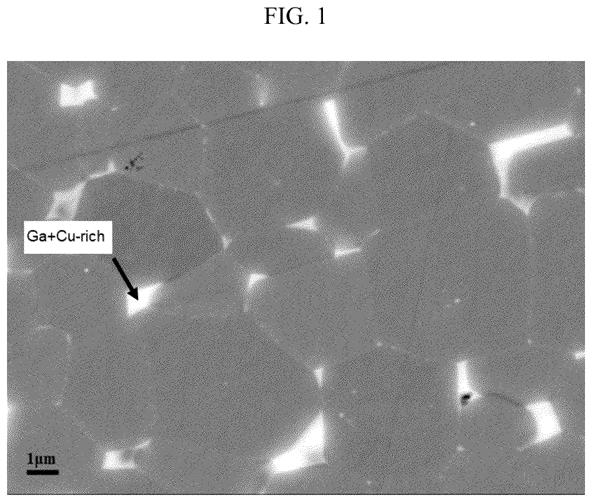

The principles and features of the present disclosure are described below in conjunction with FIG. 1 to FIG. 5, and the examples given are only used to explain the present disclosure and are not used to limit the scope of the present disclosure.

### EXAMPLES

According to the difference between components, component contents and process conditions, the following examples are performed.

### Example 1

(S1) Mixing materials: the prepared raw materials were melted in a vacuum induction melting furnace, and flakes were prepared by a strip casting method, where the melting temperature is 1450° C., and the thickness of the flakes is controlled to be 0.25 mm to 0.35 mm.

(S2) The alloy flakes were subjected to hydrogen decrepitation treatment in a hydrogen treatment furnace to obtain hydrogen decrepitation powder, and the hydrogen decrepitation powder were subjected to air-jet milling and pulverization under a nitrogen atmosphere to control the powder particle size to be X50=4.0 μm.

(S3) Under nitrogen protection, the magnetic powder obtained in (S2) was oriented and pressed in a magnetic field of 2.0T to form a green body.

(S4) The pressed green body was sintered in a vacuum sintering furnace at a sintering temperature of 1060° C. for 6 h and then rapidly cooling. Two-stage aging treatment was performed on the sintered magnet, in which primary aging treatment was first performed at 850° C. for 3 h and then rapidly cooling; then secondary aging treatment was performed at a temperature of 490° C. for 3 h. In thermal-insulation stages of the secondary aging treatment, argon gas was introduced to the atmosphere pressure of 0.03 MPa, and then rapid cooling was performed. In cooling stages of the secondary aging, argon gas was introduced to the atmosphere pressure of 0.06 MPa, and finally a sintered NdFeB magnet was obtained.

Referring to the process steps of Example 1, the content of each component and the process conditions were adjusted to form Examples 2 to 6, where the components and their contents of respective examples are shown in Table 1, and the process conditions of respective examples are shown in Table 2.

TABLE 1
Element components and their contents in Examples 1 to 6

| | wt % | | | | | | | | | | |
|---|---|---|---|---|---|---|---|---|---|---|---|
| No. | Al | B | Co | Fe | Cu | Ga | Ti | Zr | Nd | Pr | ΣRe |
| Example 1 | 0 | 0.96 | 0.3 | bal. | 0.5 | 0.05 | 0.05 | / | 21 | 8.5 | 29.5 |
| Example 2 | 0.35 | 0.90 | 0.5 | bal. | 0.47 | 0.23 | 0.25 | 0.15 | 22.5 | 8 | 30.5 |
| Example 3 | 0.5 | 0.92 | 0.3 | bal. | 0.55 | 0.2 | 0.25 | / | 23.5 | 7.5 | 31 |
| Example 4 | 0.3 | 0.85 | 0.3 | bal. | 0.5 | 0.18 | 0.15 | / | 23.5 | 8 | 31.5 |
| Example 5 | 0.55 | 0.90 | 0.5 | bal. | 0.75 | 0.2 | 0.3 | 0.1 | 22 | 10 | 32 |
| Example 6 | 0.55 | 0.98 | 0.5 | bal. | 1.5 | 0.15 | 0.3 | / | 23.5 | 9.5 | 33 |

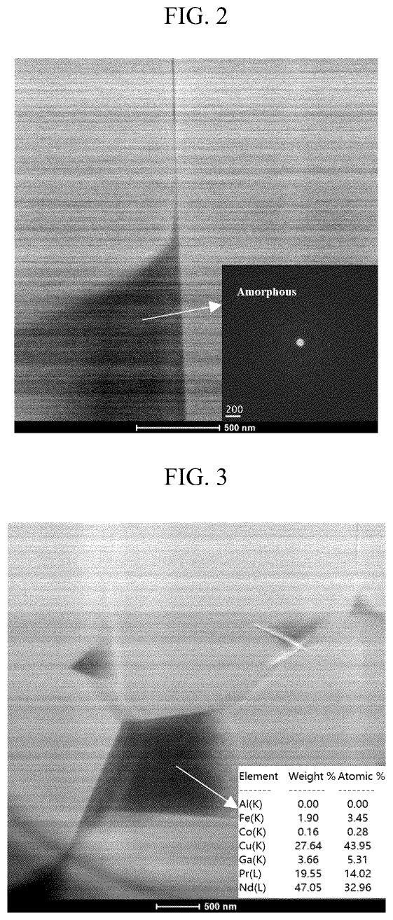

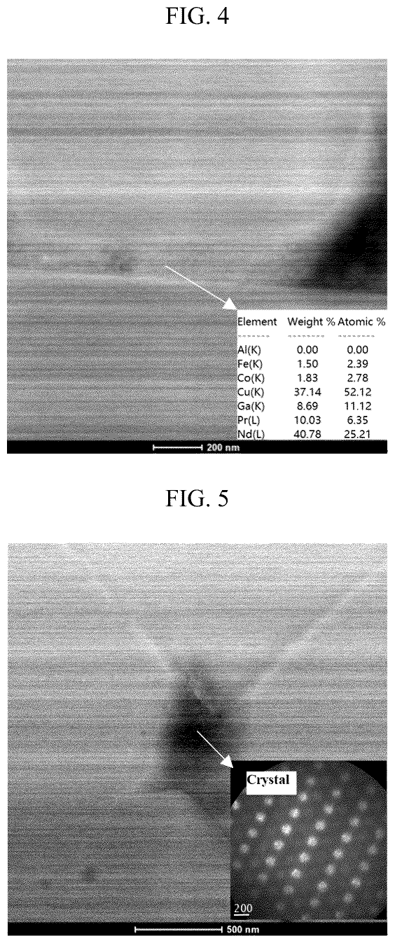

The NdFeB magnets obtained in the above examples include a main phase Re₂Fe₁₄B, a Re-containing grain boundary phase (Ga+Cu-rich amorphous phase at the grain boundary triangle region, a Ga+Cu-rich amorphous grain boundary phase formed among adjacent main phase grains) and a rare earth-rich phase. As shown in FIG. 1, the microstructure of the magnet of Example 1 is shown, and the triangle region of the magnet is a Ga+Cu-rich phase. As shown in FIG. 2, it is the electron diffraction spectrum of the triangle region of the grain boundary of the magnet of Example 1, from which it can be known that the grain boundary phase here is an amorphous structure. As shown in FIG. 3, it is the energy spectrum of the triangle region of the magnet grain boundary of Example 1, from which it can be known that the grain boundary phase here has rich Ga+Cu both and has a low Fe content. FIG. 4 shows the energy spectrum of the grain boundary between two magnet particles in Example 1, from which it can be known that the grain boundary phase here has rich Ga+Cu both and has a low Fe content.

TABLE 2
Process conditions of Examples 1 to 6

| | | | | | | Secondary |
|---|---|---|---|---|---|---|
| | | | | | | aging |
| | | Alloy | Magnetic | Secondary | Secondary aging | cooling |
| | Melting | powder | field | aging | thermal-insulation | atmosphere |
| | temperature, | particle | strength, | temperature, | atmosphere | pressure, |
| | ° C. | size, μm | T | ° C. | pressure, MPa | MPa |
| Example | 1450 | 4.0 | 2.0 | 490 | 0.03 | 0.06 |
| 1 | | | | | | |
| Example | 1450 | 5.0 | 2.0 | 490 | 0.02 | 0.06 |
| 2 | | | | | | |
| Example | 1500 | 3.5 | 1.8 | 460 | 0.04 | 0.08 |
| 3 | | | | | | |
| Example | 1500 | 3.5 | 1.8 | 500 | 0.04 | 0.07 |
| 4 | | | | | | |
| Example | 1400 | 3.0 | 1.5 | 520 | 0.05 | 0.07 |
| 5 | | | | | | |
| Example | 1400 | 2.5 | 1.5 | 520 | 0.05 | 0.06 |
| 6 | | | | | | |

The image processing method was used to calculate the area percentage of the first grain boundary phase, where the processed images were taken by a Scanning Electron Microscope (ZEISS EVO MA10) with a magnification of 500×, five groups of images were taken for respective examples and the average value was taken, and the area percentage of the first grain boundary phase and the width of the second grain boundary phase of respective examples are shown in Table 3.

TABLE 3
NdFeB magnet structures in Example 1 to Example 6

| | Whether an | Area percentage of | Width of the |
|---|---|---|---|
| | amorphous | the first grain | second grain |
| | phase is | boundary phase | boundary phase |
| Sample Type | generated | (%) | (nm) |
| Example 1 | Yes | 6.3 | 2 |
| Example 2 | Yes | 8.5 | 3 |
| Example 3 | Yes | 10.1 | 10 |
| Example 4 | Yes | 12.9 | 12 |
| Example 5 | Yes | 14 | 16 |
| Example 6 | Yes | 14.5 | 20 |

### COMPARATIVE EXAMPLES

In order to verify the technical effect of examples, the following comparative examples were set. The specific process steps are:

### Comparative Example 1

(A1) According to the proportion of magnet components, an alloy was smelted and sliced to prepare flakes were prepared by an alloy-melting and casting method, where the smelting temperature is 1450° C. and the thickness of the flakes is controlled to be 0.25 mm to 0.35 mm.

(A2) The alloy flakes were subjected to hydrogen decrepitation treatment in a hydrogen treatment furnace to obtain hydrogen decrepitation powder; the hydrogen decrepitation powder was subjected to air-jet milling treatment, using nitrogen to grind the powder, and the powder particle size is controlled at X50=4.0 μm.

(A3) Under nitrogen protection, the NdFeB powder was oriented and pressed in a magnetic field of 2.0T.

(A4) The pressed green body was sintered in a vacuum sintering furnace at a sintering temperature of 1060° C. for 6 h. Then, argon gas was introduced for rapid cooling. The sintered magnet was subjected to two-stage aging treatment, which firstly, it is kept at 850° C. for 3 h and then rapidly cooled; and it is then subjected to secondary aging treatment, where the temperature is raised to 490° C. and kept for 3 h. No argon is introduced during the thermal-insulation stage of the secondary aging, and then the product was rapidly cooled, and during the secondary aging and cooling stage, argon was introduced until the atmosphere pressure reaches 0.05 MPa, and finally a sintered NdFeB magnet was obtained.

Referring to the process steps of Comparative Example 1, the content of each component and the process conditions are adjusted to form Comparative Examples 2 to 6, wherein the components and their contents of respective comparative examples are shown in Table 4, and the process conditions of respective comparative examples are shown in Table 5.

TABLE 4
Element components and their contents in Comparative Examples 1 to 6

| | wt % | | | | | | | | | | |
|---|---|---|---|---|---|---|---|---|---|---|---|
| No. | Al | B | Co | Fe | Cu | Ga | Ti | Zr | Nd | Pr | ΣRe |
| Comparative | 0.1 | 0.96 | 0.3 | bal. | 0.15 | 0.55 | 0.1 | / | 21 | 8.5 | 29.5 |
| Example 1 | | | | | | | | | | | |
| Comparative | 0.35 | 0.95 | 0.95 | bal. | 0.3 | 0.5 | 0.25 | 0.15 | 22.5 | 8 | 30.5 |
| Example 2 | | | | | | | | | | | |
| Comparative | 0.5 | 0.92 | 0.3 | bal. | 0.2 | 0.35 | 0.2 | / | 23.5 | 7.5 | 31 |
| Example 3 | | | | | | | | | | | |
| Comparative | 0.3 | 0.85 | 0.3 | bal. | 0.35 | 0.4 | 0.35 | / | 23.3 | 8 | 31.3 |
| Example 4 | | | | | | | | | | | |
| Comparative | 0.55 | 0.90 | 0.5 | bal. | 0.3 | 0.6 | 0.18 | 0.1 | 22 | 10.5 | 32.5 |
| Example 5 | | | | | | | | | | | |
| Comparative | 0.55 | 0.98 | 0.5 | bal. | 0.3 | 0.75 | 0.3 | / | 23.5 | 9.5 | 33 |
| Example 6 | | | | | | | | | | | |

TABLE 5
Process conditions of Comparative Examples 1 to 6

| | | | | | | Secondary |
|---|---|---|---|---|---|---|
| | | | | | | aging |
| | | Alloy | Magnetic | Secondary | Secondary aging | cooling |
| | Melting | powder | field | aging | thermal-insulation | atmosphere |
| | temperature, | particle | strength, | temperature, | atmosphere | pressure, |
| | ° C. | size, μm | T | ° C. | pressure, MPa | MPa |
| Comparative | 1450 | 4.0 | 2.0 | 490 | 0 | 0.05 |
| Example 1 | | | | | | |
| Comparative | 1450 | 5.2 | 2.0 | 490 | 0.02 | 0.05 |
| Example 2 | | | | | | |
| Comparative | 1500 | 3.5 | 1.8 | 440 | 0 | 0.06 |
| Example 3 | | | | | | |
| Comparative | 1500 | 3.5 | 1.8 | 640 | 0.03 | 0.08 |
| Example 4 | | | | | | |
| Comparative | 1400 | 3.0 | 1.5 | 500 | 0 | 0.03 |
| Example 5 | | | | | | |
| Comparative | 1400 | 2.5 | 1.5 | 520 | 0.01 | 0 |
| Example 6 | | | | | | |

As shown in FIG. 5, this is the electron diffraction pattern at the triangle region of the grain boundary of the magnet of Comparative Example 1, from which it can be seen that the grain boundary phase here is a crystalline structure. Similarly, the image processing method was used to calculate the area percentage of the first grain boundary phase, where the processed images were taken by a Scanning Electron Microscope (ZEISS EVO MA10) with a magnification of 500×, five groups of images were taken for respective examples and the average value was taken, and the area percentage of the first grain boundary phase and the width of the second grain boundary phase of respective comparative examples are shown in Table 6.

TABLE 6
NdFeB magnet structures in Comparative Examples 1 to 6

| | | Area percentage of | Width of the |
|---|---|---|---|
| | Whether an | the first grain | second grain |
| | amorphous phase | boundary phase | boundary phase |
| Sample Type | is generated | (%) | (nm) |
| Comparative | No | 6.1 | 1 |
| Example 1 | | | |
| Comparative | No | 8.9 | 3 |
| Example 2 | | | |
| Comparative | No | 10.5 | 5 |
| Example 3 | | | |
| Comparative | No | 13.2 | 10 |
| Example 4 | | | |
| Comparative | No | 13.8 | 12 |
| Example 5 | | | |
| Comparative | No | 14.9 | 25 |
| Example 6 | | | |

In order to further verify the superior performance of the NdFEB magnets in the Examples, the NdFeB magnets obtained from the Examples and the Comparative Examples were tested using a NIM 2000 magnetic properties measuring instrument, as shown in Table 7.

TABLE 7
NdFeB magnet structures in Examples 1
to 6 and Comparative Examples 1 to 6

| | | | 20° C. to | 20° C. to |
|---|---|---|---|---|
| | | | 70° C. Hcj | 140° C. Hcj |
| | | | temperature | temperature |
| | | | coefficient β | coefficient β |
| Sample Type | Br(KGs) | Hcj(KOe) | (Hcj)% | (Hcj)% |
| Example 1 | 14.57 | 18.52 | 0.647 | |
| Example 2 | 14.33 | 19.2 | 0.653 | |
| Example 3 | 13.95 | 20.5 | | 0.501 |
| Example 4 | 13.87 | 20.87 | | 0.498 |
| Example 5 | 13.4 | 21.77 | | 0.511 |
| Example 6 | 13.26 | 22.7 | | 0.509 |
| Comparative | 14.5 | 18.1 | 0.693 | |
| Example 1 | | | | |
| Comparative | 14.25 | 18.76 | 0.701 | |
| Example 2 | | | | |
| Comparative | 13.92 | 19.86 | | 0.545 |
| Example 3 | | | | |
| Comparative | 13.8 | 20.25 | | 0.562 |
| Example 4 | | | | |
| Comparative | 13.4 | 21 | | 0.553 |
| Example 5 | | | | |
| Comparative | 13.2 | 22.5 | | 0.556 |
| Example 6 | | | | |

It can be seen from the above data that the magnets prepared by the present disclosure has the characteristics of high magnetic properties and good temperature coefficient.

The above description is only a preferred embodiment of the present disclosure and is not intended to limit the present disclosure, and any modifications, equivalent substitutions, improvements, etc. made within the spirit and principles of the present disclosure shall be included in the protection scope of the present disclosure.

What is claimed is:

1. A high-performance and high-thermal-stability sintered NdFeB magnet, wherein: the NdFeB magnet comprising a Re₂Fe₁₄B main phase, a grain boundary phase containing Re and a rare earth-rich phase, the grain boundary phase comprising a first grain boundary phase and a second grain boundary phase; the Re is one or more of rare earth elements and contains at least one of Pr and Nd, the first grain boundary phase is a Ga+Cu-rich amorphous phase in the grain boundary triangle region, the second grain boundary phase is a Ga+Cu-rich amorphous grain boundary phase formed among adjacent main phase grains, and the rare earth-rich phase is Re—O and Re—N; a mass percentage of the Re₂Fe₁₄B main phase, the first grain boundary phase and the second grain boundary phase in the NdFeB magnet is defined as X, 97%≤X<100%.

2. The high-performance and high-thermal-stability sintered NdFeB magnet according to claim 1, wherein on any cross-section of the NdFEB magnet, an area percentage of the first grain boundary phase is 6% to 15%, and a width of the second grain boundary phase is 2 nm to 20 nm; a total mass of Ga and Cu in the first grain boundary phase accounts for 20% to 40% of a total mass of the first grain boundary phase, and a mass content of Fe in the first grain boundary phase is 0% to 10%; a total mass content of Ga and Cu in the second grain boundary phase accounts for 40% to 70% of a total mass of the second grain boundary phase, and a mass content of Fe in the second grain boundary phase is 0% to 10%.

3. The high-performance and high-thermal-stability sintered NdFeB magnet according to claim 1, wherein elements and their contents in the NdFEB magnet are: Re: 29.5 wt % to 33 wt %, B: 0.85 wt % to 0.98 wt %, M: 0.5 wt % to 5 wt %, Fe: 61 wt % to 69 wt %; M containing at least two elements, Cu and Ga, and at least one of Co, Ti, Zr, V, Mo, and Nb, and a mass content of Cu is greater than 0.45%, and a mass content of Ga is less than 0.25%, wherein a mass content ratio of Cu to Ga is defined as Y, 1.8<Y≤10.

4. The high-performance and high-thermal-stability sintered NdFeB magnet according to claim 2, wherein elements and their contents in the NdFeB magnet are: Re: 29.5 wt % to 33 wt %, B: 0.85 wt % to 0.98 wt %, M: 0.5 wt % to 5 wt %, Fe: 61 wt % to 69 wt %; M containing at least two elements, Cu and Ga, and at least one of Co, Ti, Zr, V, Mo, and Nb, and a mass content of Cu is greater than 0.45%, and a mass content of Ga is less than 0.25%, wherein a mass content ratio of Cu to Ga is defined as Y, 1.8<Y≤10.

5. A method for preparing a high-performance and high-thermal-stability sintered NdFeB magnet, comprising the following steps:
(S1) mixing materials and preparing an alloy flake by using a strip casting process, wherein a smelting process in the strip casting process is performed under argon protection;
(S2) treating the alloy flake with hydrogen and pulverizing by air-jet milling to obtained an alloy powder;
(S3) magnetic-forming the alloy powder in a uniform magnetic field, and preparing a green body by cold isostatic pressing;
(S4) sintering the green body in a vacuum sintering furnace, and then performing an aging treatment, wherein the aging treatment is a two-stage tempering heat treatment, and a thermal-insulation stage and a cooling structure in the two-stage tempering heat treatment are both performed under an inert atmosphere.

6. The method for preparing the high-performance and high-thermal-stability sintered NdFeB magnet according to claim 5, wherein a temperature of the smelting process in (S1) is 1400° C. to 1500° C.

7. The method for preparing a high-performance and high-thermal-stability sintered NdFeB magnet according to claim 5, wherein a particle size of the alloy powder prepared by air-jet milling in (S2) is 2.5 μm to 5 μm.

8. The method for preparing a high-performance and high-thermal-stability sintered NdFeB magnet according to claim 5, wherein a magnetic field intensity for magnetic-forming in (S3) is 1.5T to 2T.

9. The method for preparing a high-performance and high-thermal-stability sintered NdFeB magnet according to claim 5, wherein a sintering temperature of the sintering process is 1030° C. to 1080° C. and a sintering time of the sintering process is 6 h to 10 h in (S4).

10. The method for preparing a high-performance and high-thermal-stability sintered NdFeB magnet according to claim 5, wherein a temperature of the primary tempering heat treatment is 800° C. to 900° C., and a time of the thermal-insulation is 3 h to 5 h; a temperature of the secondary tempering heat treatment is 460° C. to 520° C., and a time of the thermal-insulation is 1 h to 6 h in (S4).

11. The method for preparing a high-performance and high-thermal-stability sintered NdFeB magnet according to claim 5, where the inert atmosphere in (S4) is argon, wherein a pressure of the inert atmosphere in the thermal-insulation stage is 0.02 MPa to 0.05 MPa, and a pressure of the inert atmosphere in the cooling stage is 0.06 MPa to 0.08 MPa.
